(19) United States
(12) Patent Application Publication
(10) Pub. No.: US 2017/0332079 A1
(43) Pub. Date: Nov. 16, 2017

(54) METHODS FOR CONTROLLING VIDEO DECODER TO SELECTIVELY SKIP ONE OR MORE VIDEO FRAMES AND RELATED SIGNAL PROCESSING APPARATUSES THEREOF

(71) Applicant: MEDIATEK, INC., Hsin-Chu City (TW)

(72) Inventors: Jian-Liang LIN, Yilan County (TW); Fang-Yi Hsieh, Taipei City (TW)

(73) Assignee: MEDIATEK, INC., Hsin-Chu City (TW)

(21) Appl. No.: 15/668,489

(22) Filed: Aug. 3, 2017

Related U.S. Application Data
(63) Continuation of application No. 13/071,526, filed on Mar. 25, 2011.
(60) Provisional application No. 61/357,205, filed on Jun. 22, 2010.

(51) Int. Cl. H04N 19/132; H04N 21/44; H04N 19/44; H04N 21/4402; H04N 19/172

(52) U.S. Cl. CPC H04N 19/132; H04N 21/440281; H04N 19/172; H04N 19/44; H04N 21/44004

(57) ABSTRACT

An exemplary method for processing an input bitstream having a plurality of video frames includes the following steps: deriving an indication data from decoding of a current video frame, and controlling a video decoder to decode or skip a next video frame by referring to at least the indication data and a video decoder capability of the video decoder. A signal processing apparatus for processing an input bitstream including a plurality of video frames includes a video decoder, an indication data estimating unit, and a controller. The video decoder is arranged to decode a current video frame. The indication data estimating unit is for deriving an indication data from decoding of the current video frame. The controller is for controlling the video decoder to decode or skip a next video frame by referring to at least the indication data and a video decoder capability of the video decoder.

### CROSS REFERENCE TO RELATED APPLICATIONS

This application is a continuation application of U.S. application Ser. No. 13/071,526, filed on Mar. 25, 2011, which claims the benefit of U.S. provisional application No. 61/357,205, filed on Jun. 22, 2010, the entire contents of each of which is hereby incorporated by reference.

### BACKGROUND

The disclosed embodiments of the present invention relate to decoding video frames, and more particularly, to methods for controlling a video decoder to selectively skip one or more video frames and related signal processing apparatuses thereof.

With the advance of semiconductor technology, more and more functions are supported by a single device. However, regarding a handheld device with operational power supplied from a battery, the overall power consumption has to be taken into consideration though the handheld device may be designed to support many functions. For example, a video decoder of the handheld device may be equipped with low computing power. Thus, when the content transmitted by a video bitstream is complex, the real-time video playback may fail due to the limited decoder capability of the video decoder. To solve this problem encountered by the video decoder having no sufficient computing power, a conventional solution is to reduce the complexity of the content, thus reduce the data rate of the video bitstream to be decoded by the video decoder. For example, a video encoder may be configured to skip/drop some predictive frames (P frames) and/or bi-directional predictive frames (B frames) included in the original video bitstream to thereby generate a modified video bitstream suitable for the video decoder with limited computing power. To put it another way, as the complexity of the content transmitted by the video bitstream is reduced, the video decoder is capable of generating decoded video frames in time, thereby realizing the desired real-time playback. However, in a case where the video bitstream with reduced content complexity is not available to the video decoder under certain conditions, the handheld device having the video decoder with limited decoder capability may still fail to generate decoded video frames for fluent video playback.

In addition, it is possible that the video playback is not synchronized with the audio playback due to the limited decoder capability. When the video playback and the audio playback are out of synchronization, it may be annoying to the viewer.

Thus, there is a need for an innovative video decoder design which can adaptively reduce complexity of the content in a video bitstream based on its decoding capability for fluent and synchronized video playback.

### SUMMARY

In accordance with exemplary embodiments of the present invention, methods for controlling a video decoder to selectively skip one or more video frames and related signal processing apparatuses thereof are proposed to solve the above-mentioned problem.

According to a first aspect of the present invention, an exemplary method for processing an input bitstream including a plurality of video frames is disclosed. The exemplary method includes the following steps: deriving an indication data from decoding of a current video frame, and controlling a video decoder to decode or skip a next video frame by referring to at least the indication data and a video decoder capability of the video decoder.

According to a second aspect of the present invention, an exemplary method for processing an input bitstream including a plurality of video frames is disclosed. The exemplary method includes the following steps: deriving an indication data from a bitstream of a current video frame before the current video frame is decoded or skipped, and controlling a video decoder to decode or skip the current video frame by referring to at least the indication data.

According to a third aspect of the present invention, an exemplary method for processing an input bitstream including a plurality of video frames and a plurality of audio frames is disclosed. The exemplary method includes the following steps: decoding the audio frames and accordingly generating decoded audio samples; and while the decoded audio samples are being continuously outputted for audio playback, controlling a video decoder to skip part of the video frames.

According to a fourth aspect of the present invention, an exemplary signal processing apparatus for processing an input bitstream including a plurality of video frames is disclosed. The exemplary signal processing apparatus includes a video decoder, an indication data estimating unit, and a controller. The video decoder is arranged to decode a current video frame. The indication data estimating unit is coupled to the video decoder, and implemented for deriving an indication data from decoding of the current video frame. The controller is coupled to the video decoder and the indication data estimating unit, and implemented for controlling the video decoder to decode or skip a next video frame by referring to at least the indication data and a video decoder capability of the video decoder.

According to a fifth aspect of the present invention, an exemplary signal processing apparatus for processing an input bitstream including a plurality of video frames is disclosed. The exemplary signal processing apparatus includes a video decoder, an indication data estimating unit, and a controller. The indication data estimating unit is arranged to derive an indication data from a bitstream of a current video frame before the current video frame is decoded or skipped. The controller is coupled to the video decoder and the indication data estimating unit, and implemented for controlling the video decoder to decode or skip the current video frame by referring to at least the indication data.

According to a sixth aspect of the present invention, an exemplary signal processing apparatus for processing an input bitstream including a plurality of video frames and a plurality of audio frames is disclosed. The exemplary signal processing apparatus includes an audio decoder, a video decoder, and a controller coupled to the video decoder. The audio decoder is arranged to decode the video frames and accordingly generate decoded audio samples. While the decoded audio samples are being continuously outputted for audio playback, the controller controls the video decoder to skip part of the video frames.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a signal processing apparatus according to a first exemplary embodiment of the present invention.

FIG. 2 is a flowchart illustrating a method employed by the signal processing apparatus shown in FIG. 1.

FIG. 3 is a flowchart illustrating a first exemplary design of step 212 shown in FIG. 2.

FIG. 4 is a flowchart illustrating a second exemplary design of step 212 shown in FIG. 2.

FIG. 5 is a diagram illustrating the relationship between a decision threshold and a total number of decoded video frames in a video frame buffer.

FIG. 6 is a diagram illustrating a signal processing apparatus according to a second exemplary embodiment of the present invention.

FIG. 7 is a flowchart illustrating a method employed by the signal processing apparatus shown in FIG. 6.

FIG. 8 is a flowchart illustrating a first exemplary design of step 710 shown in FIG. 7.

FIG. 9 is a flowchart illustrating a second exemplary design of step 710 shown in FIG. 7.

FIG. 10 is a diagram illustrating a signal processing apparatus according to a third exemplary embodiment of the present invention.

FIG. 11 is a diagram illustrating an operational scenario of the signal processing apparatus shown in FIG. 10.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

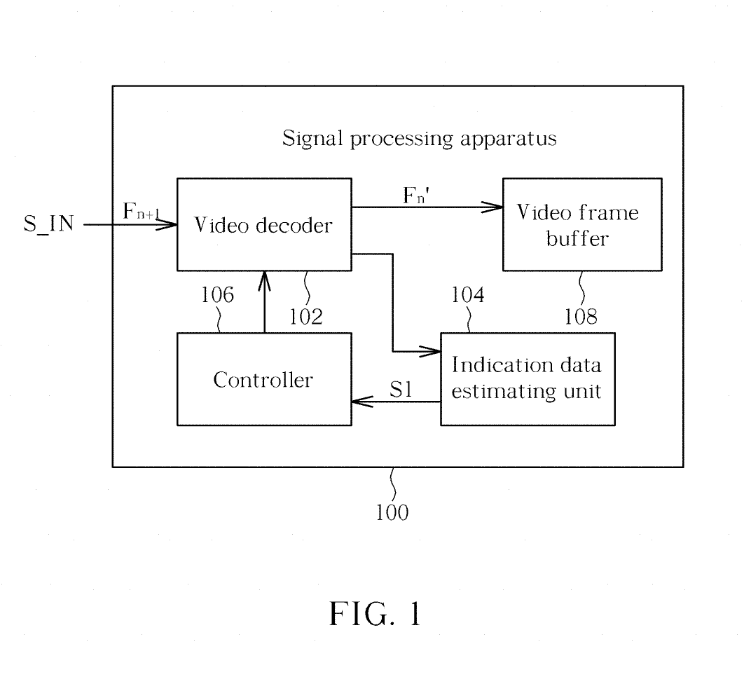

FIG. 1 is a diagram illustrating a signal processing apparatus according to a first exemplary embodiment of the present invention. The exemplary signal processing apparatus 100 is for processing an input bitstream S_IN having a plurality of encoded/compressed video frames included therein. The exemplary signal processing apparatus 100 includes, but is not limited to, a video decoder 102, an indication data estimating unit 104, a controller 106, and a video frame buffer 108. The video decoder 102 is arranged to skip or decode a video frame under the control of the controller 106. When a current video frame Fₙ is allowed to be decoded, the video decoder 102 generates a decoded video frame Fₙ′ to the video frame buffer 108 by decoding the current video frame Fₙ transmitted by the input bitstream S_IN. The indication data estimating unit 104 is coupled to the video decoder 102, and implemented for deriving an indication data S1 from decoding of the current video frame Fₙ. In this exemplary embodiment, the indication data S1 includes information indicative of complexity of the current video frame Fₙ relative to previous video frame(s), such as F₀-Fₙ₋₁ previously transmitted by the input bitstream S_IN. The controller 106 is coupled to the video decoder 102 and the indication data estimating unit 104, and implemented for controlling the video decoder 102 to decode or skip a next video frame Fₙ₊₁ by referring to at least the indication data S1 and a video decoder capability of the video decoder 102. The operations and functions of these blocks included in the signal processing apparatus 100 are detailed as follows.

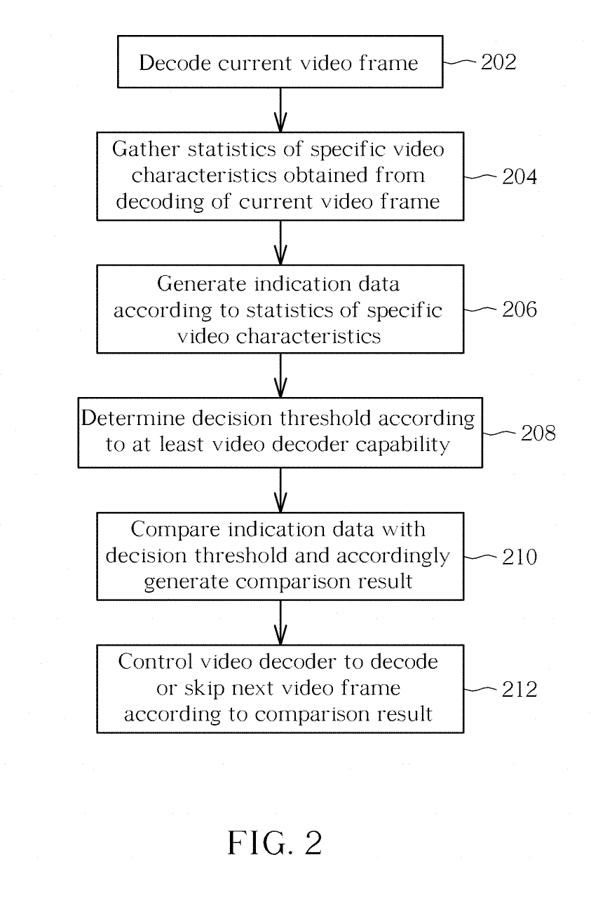

Please refer to FIG. 2, which is a flowchart illustrating a method employed by the signal processing apparatus shown in FIG. 1. Provided that the result is substantially the same, the steps are not required to be executed in the exact order shown in FIG. 2. The exemplary method for determining whether the next video frame should be skipped or decoded can be briefly summarized as follows.

Step 202: Decode a current video frame.

Step 204: Gather statistics of specific video characteristics obtained from decoding of the current video frame.

Step 206: Generate an indication data according to the gathered statistics of specific video characteristics.

Step 208: Determine a decision threshold according to at least the video decoder capability of the video decoder.

Step 210: Compare the indication data with the decision threshold and accordingly generate a comparison result.

Step 212: Control a video decoder to decode or skip the next video frame according to the comparison result.

In this exemplary embodiment, the indication data estimating unit 104 obtains the indication data S1 by performing steps 204 and 206. For example, the indication data estimating unit 104 generates the indication data S1 by calculating an accumulation value of the specific video characteristics corresponding to the current video frame Fₙ decoded by the video decoder 102, calculating a weighted average value of the accumulation value and a historical average value derived from the previous video frame(s), and determining the indication data S1 according to the accumulation value and the weighted average value. By way of example, but not limitation, the specific video characteristics used for determining the indication data may be motion vectors, or discrete cosine transform (DCT) coefficients, or macroblock types (partition sizes and partition types). In one exemplary implementation, the indication data S1 transmitted to the controller 106 may be a value indicative of a ratio between the accumulation value and the weighted average value. In another exemplary implementation, the indication data S1 transmitted to the controller 106 may include the accumulation value and the weighted average value.

In a case where motion vectors obtained during the decoding of the current video frame Fₙ are used for determining the indication data S1, the indication data estimating unit 104 obtains an accumulated motion vector MV_{F}_{ₙ} according to the following formula.

$${MV}_{{F}_{N}} = {\sum }_{b - 0}^{BlockNum 1} ( \vert {MV}_{x , b} \vert + \vert {MV}_{y , b} \vert ) \qquad ( 1 )$$

In above formula (1), BlockNum represents the total number of blocks in the current video frame Fₙ, and MV_{x,b} and MV_{y,b} represent motion vectors of x-dimension and y-dimension of a block indexed by a block index value b, respectively. It should be noted that an intra-coded block may be regarded as having infinitely large motion vectors in some embodiments. Thus, MV_{x,b} and MV_{y,b} are directly assigned by predetermined values (e.g., |MV_{x,b}|=|MV_{y,b}|=max MV) when a block indexed by a block index value b is an intra-coded block.

After the accumulation value MV_{F}_{ₙ} corresponding to the current video frame Fₙ is obtained, the indication data estimating unit 104 calculates a weighted average value MV_{T}_{ₙ} of the accumulation value MV_{F}_{ₙ} and a historical accumulation value MV_{T}_{_{n−1}} derived from previous video frames (i.e., previous decoded video frames). The weighted average value MV_{T}_{ₙ} can be expressed as follows:

MV_{T}_{ₙ}=α×MV_{T}_{_{n−1}}+(1−α)×MV_{F}_{ₙ} (2)

In above formula (2), α represents a weighting vector. The historical accumulation value MV_{T}_{_{n−1}} represents the historical statistics of motion vectors of previous decoded video frames. Therefore, the weighted average value MV_{T}_{ₙ} will become a historical accumulation value, representative of the historical statistics of motion vectors of previous decoded video frames, for calculating a next weighted average value.

Next, the indication data estimating unit 104 determines the indication data S1 according to the accumulation value MV_{F}_{ₙ} and the weighted average accumulation value MV_{T}_{ₙ}. For example, the indication data estimating unit 104 determines the indication data S1 according to a ratio between the accumulation value MV_{F}_{ₙ} and the weighted average accumulation value MV_{T}_{ₙ}. In such an exemplary implementation, the indication data S1 may be expressly as follows:

$$S 1 = \frac{{MV}_{{F}_{n}}}{{MV}_{{T}_{n}}} \qquad ( 3 )$$

As can be seen from formula (3), the indication data S1 may be regarded as a comparison result of comparing the statistics of motion vectors of the current decoded video frame with the historical statistics of motion vectors of previous decoded video frame(s). In a case where each of the video frames included in the input bitstream S_IN has the same number of blocks, the indication data S1 is equivalent to a ratio of an average motion vector of the current video frame to an average motion vector in the time domain (i.e., a moving average of motion vectors of previous video frames).

The controller 106 controls the video decoder 102 to decode or skip the next video frame Fₙ₊₁ by performing steps 208-212. Thus, the controller 106 decides whether the next video frame Fₙ₊₁ will be skipped or decoded by referring to the comparison result (i.e.,

$$\frac{{MV}_{{F}_{n}}}{{MV}_{{T}_{n}}} \text{)} .$$

In this exemplary embodiment, the controller 106 further determines a decision threshold R according to at least the video decoder capability of the video decoder 102. Therefore, the controller 106 controls the video decoder 106 to decode or skip the next video frame Fₙ₊₁ according to a comparison result derived from the indication data S1 and the decision threshold R. For example, the controller 106 compares the indication data S1 with the decision threshold R and accordingly generates a comparison result, and controls the video decoder 102 to decode or skip the next video frame Fₙ₊₁ according to the comparison result.

Certain factors/parameters may reflect the video decoder capability of the video decoder 102. For example, the controller 106 may set the decision threshold R according to at least a ratio between a video decoder frame rate R1 and an input video frame rate R2 (e.g.,

$$\frac{R 1}{R 2} \text{)} .$$

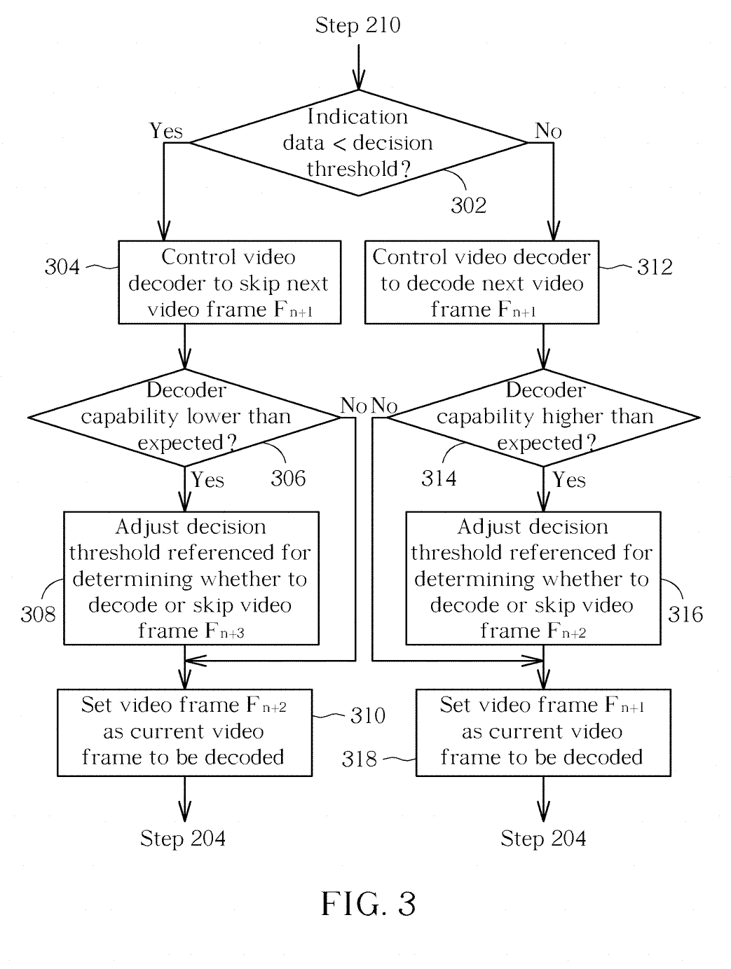

Please refer to FIG. 3, which is a flowchart illustrating a first exemplary design of step 212 shown in FIG. 2. The operation of controlling the video decoder 102 to decode or skip the next video frame Fₙ₊₁ may include following steps.

Step 302: Check if the indication data S1 is smaller than the decision threshold R. If yes, go to step 304; otherwise, go to step 312.

Step 304: Control the video decoder 102 to skip the next video frame Fₙ₊₁.

Step 306: Check if the video decoder capability of the video decoder 102 does not match (e.g., lower than) an expected video decoder capability. If yes, go to step 308; otherwise, go to step 310.

Step 308: Adjust the decision threshold R referenced for determining whether to decode or skip a video frame Fₙ₊₃.

Step 310: Set the video frame Fₙ₊₂ following the next video frame Fₙ₊₁ as a current video frame to be decoded. Go to step 204.

Step 312: Control the video decoder 102 to decode the next video frame Fₙ₊₁.

Step 314: Check if the video decoder capability of the video decoder 102 does not match (e.g., higher than) the expected video decoder capability. If yes, go to step 316; otherwise, go to step 318.

Step 316: Adjust the decision threshold R referenced for determining whether to decode or skip a video frame Fₙ₊₂ following the next video frame Fₙ₊₁.

Step 318: Set the next video frame Fₙ₊₁ as a current video frame to be decoded. Go to step 204.

It should be noted that the decision threshold R is set by an initial value Rᵢₙᵢ corresponding to an expected video decoder capability of the video decoder 102. For example, the expected decoder frame rate R1ₑₓₚ and the expected input video frame rate R2ₑₓₚ are known in advance, and the decision threshold R would be initialized by the ratio between the expected decoder frame rate R1ₑₓₚ and the expected input video frame rate R2ₑₓₚ (e.g.,

$${R}_{ini} = \frac{R {1}_{exp}}{R {2}_{exp}} \text{)}$$

or a value proportional to this ratio. Thus, when the video decoder 102 is dealing with the first video frame F₀ of the input bitstream S_IN, the decision threshold R set by the initial value Rᵢₙᵢ would be used in step 302. In addition, the decision threshold R may be adaptively/dynamically updated in the following procedure for dealing with subsequent video frames (step 308/316).

When the indication data S1 (e.g.,

$$\frac{{MV}_{{F}_{n}}}{{MV}_{{T}_{n}}} \text{)}$$

is found smaller than the current decision threshold R, it implies that the complexity of the current video frame Fₙ relative to previous video frames F₀-Fₙ₋₁ is low. There is a high possibility that the complexity of the next video frame Fₙ₊₁ relative to previous video frames F₀-Fₙ is also low. Based on such assumption, the controller 102 judges that decoding of the next video frame Fₙ₊₁ is allowed to be skipped when the indication data S1 is found smaller than the current decision threshold R (steps 302 and 304). On the other hand, the controller 102 judges that decoding of the next video frame Fₙ₊₁ should be performed when the indication data S1 is not smaller than the current decision threshold R (steps 302 and 312).

As mentioned above, the decision threshold R may be adaptively updated in this exemplary embodiment. In step 306, it is checked to see if the video decoder capability of the video decoder 102 is lower than the expected video decoder capability. For example, the ratio of the actual decoder frame rate R1_{act} to the actual input video frame rate R2_{act} (i.e., the ratio of the number of decoded video frames to the number of input video frames) is compared with the ratio of the expected decoder frame rate R1ₑₓₚ to the expected input video frame rate R2ₑₓₚ. When

$$\frac{R {1}_{act}}{R {2}_{act}}$$

is smaller than

$$\frac{R {1}_{exp}}{R {2}_{exp}} ,$$

it implies that too many frames are skipped due to the decision threshold R higher than what is actually needed. Thus, the decision threshold R will be decreased to make the subsequent video frame tend to be decoded. On the other hand, when

$$\frac{R {1}_{act}}{R {2}_{act}}$$

is not smaller than

$$\frac{R {1}_{exp}}{R {2}_{exp}} ,$$

no adjustment is made to the current decision threshold R. The operations of steps 306 and 308 can be expressed as follows.

$$\begin{matrix}R = R \times {β}_{1} , if \frac{R {1}_{act}}{R {2}_{act}} < \frac{R {1}_{exp}}{R {2}_{exp}} & ( 4 ) \\ R = R , if \frac{R {1}_{act}}{R {2}_{act}} = \frac{R {1}_{exp}}{R {2}_{exp}} or \frac{R {1}_{act}}{R {2}_{act}} > \frac{R {1}_{exp}}{R {2}_{exp}} & ( 5 )\end{matrix}$$

In above formulas (4) and (5), β₁ is a scaling factor between 0 and 1 (i.e., 0<β₁<1).

In step 314, it is checked to see if the video decoder capability of the video decoder 102 is higher than the expected video decoder capability. For example, the ratio of the actual decoder frame rate R1_{act} to the actual input video frame rate R2_{act} (i.e., the ratio of the number of decoded video frames to the number of input video frames) is compared with the ratio of the expected decoder frame rate R1ₑₓₚ to the expected input video frame rate R2ₑₓₚ. When

$$\frac{R {1}_{act}}{R {2}_{act}}$$

exceeds

$$\frac{R {1}_{exp}}{R {2}_{exp}} ,$$

it implies that too many frames are decoded due to the current decision threshold R lower than what is actually needed. Thus, the decision threshold R will be increased to make the video frame tend to be skipped. On the other hand, when

$$\frac{R {1}_{act}}{R {2}_{act}}$$

does not exceed

$$\frac{R {1}_{exp}}{R {2}_{exp}} ,$$

no adjustment is made to the current decision threshold R. The operations of steps 314 and 316 can be expressed as follows.

$$\begin{matrix}R = \frac{R}{{β}_{2}} , if \frac{R {1}_{act}}{R {2}_{act}} > \frac{R {1}_{exp}}{R {2}_{exp}} & ( 6 ) \\ R = R , if \frac{R {1}_{act}}{R {2}_{act}} = \frac{R {1}_{exp}}{R {2}_{exp}} or \frac{R {1}_{act}}{R {2}_{act}} < \frac{R {1}_{exp}}{R {2}_{exp}} & ( 7 )\end{matrix}$$

In above formulas (6) and (7), β₂ is a scaling factor between 0 and 1 (i.e., 0<β₂<1). It should be noted that the scaling factor β₁ may be equal to or different from the scaling factor β₂, depending upon actual design consideration.

The decision threshold R may be adaptively updated according to above formulas (3)-(7) for better video decoding performance. However, this is for illustrative purposes only, and is not meant to be a limitation of the present invention. That is, the spirit of the present invention is obeyed as long as the video decoder capability of the video decoder is referenced for determining the decision threshold R.

The video frames of the input bitstream S_IN include intra-coded frames (I-frames), predictive frames (P-frames), and Bi-directional predictive frames (B-frames). In general, I-frames are the least compressible but don't require other video frames to decode, P-frames can use data from previous frames to decompress and are more compressible than I-frames, and B-frames can use both previous and following frames for data reference to get the highest amount of data compression. Therefore, skipping/dropping a B-frame is more preferable than skipping/dropping a P-frame, and skipping/dropping a P-frame is more preferable than skipping/dropping an I-frame. In an alternative design, the decision thresholds are set or adaptively updated for different frame types, respectively. That is, the controller 106 is arranged to set the decision threshold R according to the ratio between the video decoder frame rate and the input video frame rate and a frame type of the next video frame. By way of example, but not limitation, decision thresholds R_I, R_P, and R_B for I-frame, P-frame, and B-frame may have the following exemplary relationship.

R_I<<R_P<R_B (8)

Under a condition where the decision thresholds R_I, R_P, and R_B are properly configured to guarantee that the above exemplary relationship is met, the aforementioned scaling factor β₁/β₂ for one frame type may be different from that for another frame type. For example, scaling factors β₁_{_}I/β₂_{_}I, β₁_{_}P/β₂_{_}P, and β₁_{_}B/β₂_{_}B for I-frame, P-frame, and B-frame may have the following exemplary relationship. However, this is for illustrative purposes only, and is not meant to be a limitation of the present invention.

β₁_{_}I<β₁_{_}P<β₁_{_}B (9)

β₂_{_}I>β₂_{_}P>β₂_{_}B (10)

In addition to the aforementioned ratio between a video decoder frame rate and an input video frame rate, the video decoder capability of the video decoder 102 may be reflected by other factors/parameters. For example, the signal processing apparatus 100 may include the video frame buffer 108 acting as a display queue for buffering decoded video frames generated from the video decoder 102. Thus, a video driving circuit (not shown) may drive a display apparatus (not shown) according to the decoded video frames buffered in the video frame buffer 108 for video playback. In an alternative exemplary embodiment, the controller 106 may set the decision threshold R according to at least a status of the video frame buffer 108. As the number of decoded video frames buffered in the video frame buffer 108 is positively correlated to the video decoder capability, the status of the video frame buffer 108 may be referenced to properly set the decision threshold R used for determining whether the next video frame Fₙ₊₁ should be decoded or skipped.

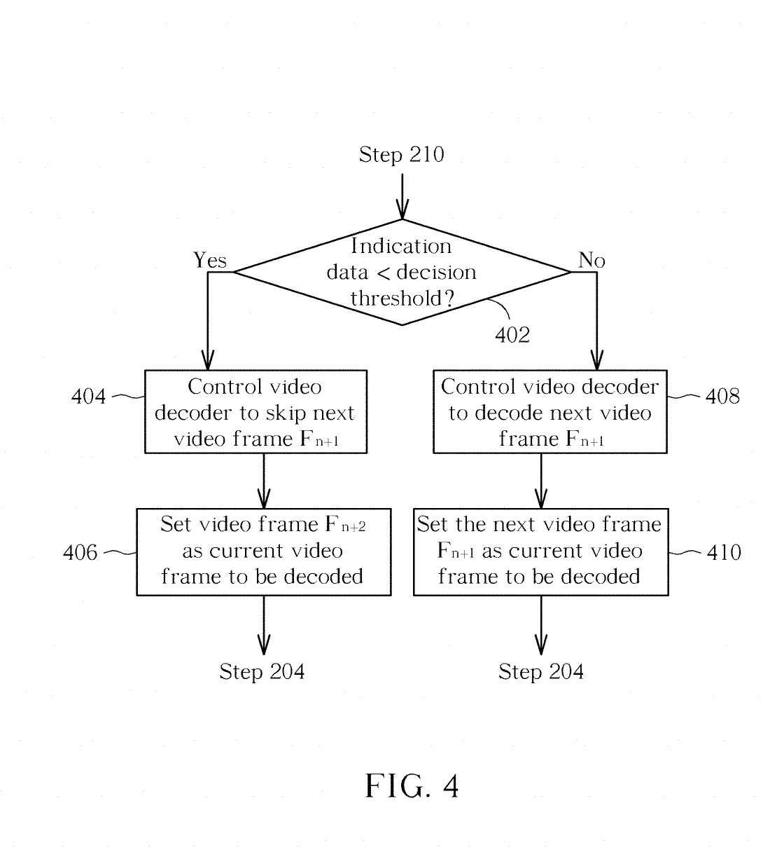

Please refer to FIG. 4, which is a flowchart illustrating a second exemplary design of step 212 shown in FIG. 2. The operation of controlling the video decoder 102 to decode or skip the next video frame Fₙ₊₁ may include following steps.

Step 402: Check if the indication data S1 is smaller than the decision threshold R(k). If yes, go to step 404; otherwise, go to step 408.

Step 404: Control the video decoder 102 to skip the next video frame Fₙ₊₁.

Step 406: Set the video frame Fₙ₊₂ following the next video frame Fₙ₊₁ as a current video frame to be decoded. Go to step 204.

Step 408: Control the video decoder 102 to decode the next video frame Fₙ₊₁.

Step 410: Set the next video frame Fₙ₊₁ as a current video frame to be decoded. Go to step 204.

It should be noted that the decision threshold R(k) may be a function of the total number of decoded video frames in the video frame buffer 108. For example, the decision threshold R(k) may be set using following formulas.

$$\begin{matrix}\begin{matrix}R ( k ) = 1 + A \times {e}^{B \times \vert j - k \vert} & , if k < j\end{matrix} & ( 11 ) \\ \begin{matrix}R ( k ) = 1 & , if k = j\end{matrix} & ( 12 ) \\ \begin{matrix}R ( k ) = \frac{1}{1 + A \times {e}^{B \times \vert k - j \vert}} & , if k > j\end{matrix} & ( 13 )\end{matrix}$$

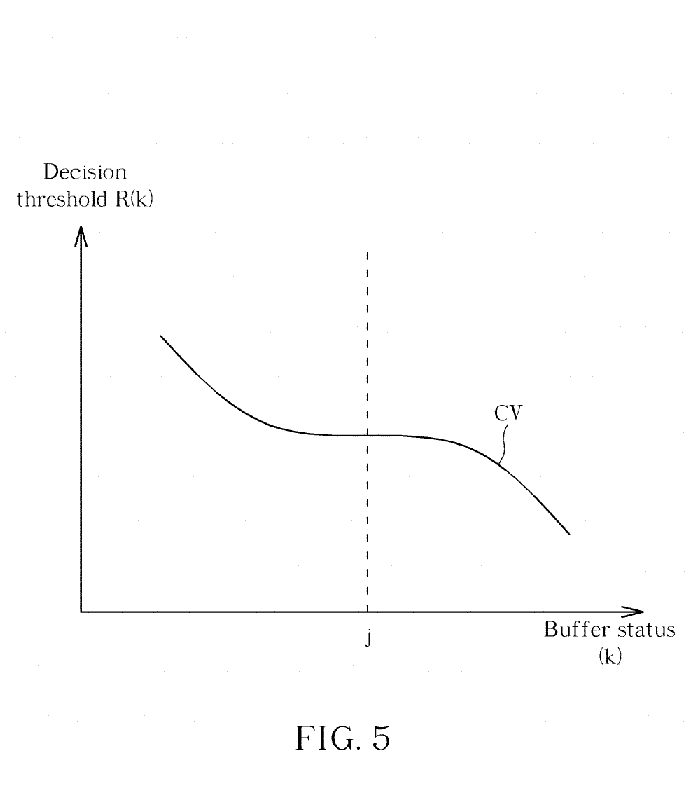

In above formulas (11)-(13), e represents the base of the natural logarithm, A and B are predetermined coefficients, k represents the total number of decoded video frames available in the video frame buffer 108, and j represents a predetermined tendency switch point. Please refer to FIG. 5, which is a diagram illustrating the relationship between the decision threshold R(k) and the total number of decoded video frames in the video frame buffer 108. The predetermined coefficients A and B define the sharpness of the characteristic curve CV. By way of example, but not limitation, A may be 1/100, and B may be 2. The tendency switch point j defines whether the decision threshold R(k) should be increased to make more frames skipped/dropped or should be decreased to make more frames decoded. More specifically, when the decision threshold R(k) is larger than 1, the next video frame Fₙ₊₁ tends to be dropped/skipped; on the other hand, when the decision threshold R(k) is smaller than 1, the next video frame Fₙ₊₁ tends to be decoded. It should be noted that the decision threshold R(k) is set in response to the total number of decoded video frames currently buffered in the video frame buffer 108 each time step 402 is executed. To put it simply, the decision threshold R(k) will be adaptively adjusted according to the instant buffer status of the video frame buffer 108.

When the indication data S1 (e.g.,

$$\frac{{MV}_{{F}_{n}}}{{MV}_{{T}_{n}}} \text{)}$$

is found smaller than the current decision threshold R(k), it implies that the complexity of the current video frame Fₙ relative to previous video frames F₀-Fₙ₋₁ is low. There is a high possibility that the complexity of the next video frame Fₙ₊₁ relative to previous video frames F₀-Fₙ is also low. Based on such assumption, the controller 102 judges that decoding of the next video frame Fₙ₊₁ is allowed to be skipped when the indication data S1 is found smaller than the current decision threshold R (step 404). On the other hand, the controller 102 judges that decoding of the next video frame Fₙ₊₁ should be performed when the indication data S1 is not smaller than the current decision threshold R (step 408).

The decision threshold R(k) may be adaptively updated according to above formulas (11)-(13) for better video decoding performance. However, this is for illustrative purposes only, and is not meant to be a limitation of the present invention. That is, the spirit of the present invention is obeyed as long as the video decoder capability of the video decoder is referenced for determining the decision threshold R(k).

In an alternative design, the decision thresholds may be set or adaptively updated for different frame types, respectively. That is, the controller 106 sets the decision threshold R(k) according to the status of the video frame buffer 108 and a frame type of the next video frame Fₙ₊₁. By way of example, but not limitation, the aforementioned threshold functions (i.e., formulas (11)-(13)) for one frame type are different from that for another frame type.

As mentioned above, the specific video characteristics used for determining the indication data may be DCT coefficients or macroblock types. Therefore, the aforementioned formula (1) can be modified to accumulate the DCT coefficients, instead of motion vectors, of the current video frame Fₙ when the specific video characteristics are DCT coefficients. The larger is the accumulation value of the DCT coefficients of the current video frame Fₙ, the complexity of the current video frame relative to previous video frame(s) is higher. Similarly, the aforementioned formula (1) can be modified to count intra-coded blocks in the current video frame Fₙ when the specific video characteristics are macroblock types. The larger is the accumulation value of the intra-coded blocks of the current video frame Fₙ, the complexity of the current video frame relative to previous video frame(s) is higher. In addition, when the specific video characteristics used for determining the indication data are DCT coefficients/macroblock types, the aforementioned formula (2) can be modified to calculate a weighted average value, and the aforementioned formula (3) can be modified to obtain the desired indication data S1. As a person skilled in the art can readily understand details of calculating the indication data according to the specific video characteristics being DCT coefficients/macroblock types after reading above paragraphs directed to calculating the indication data S1 according to the specific video characteristics being motion vectors, further description is omitted here for brevity.

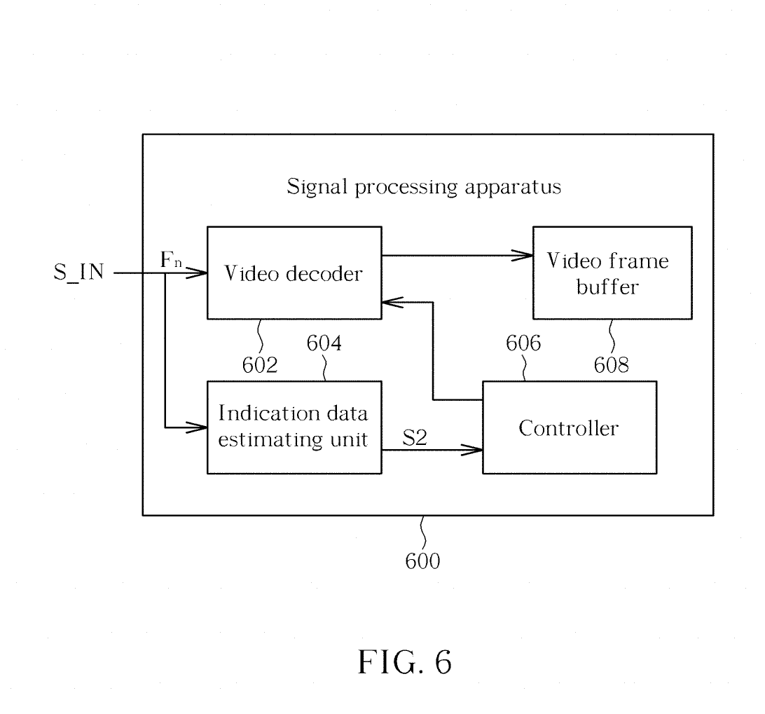

FIG. 6 is a diagram illustrating a signal processing apparatus according to a second exemplary embodiment of the present invention. The exemplary signal processing apparatus 600 is for processing an input bitstream S_IN having a plurality of encoded/compressed video frames included therein. The exemplary signal processing apparatus 600 includes, but is not limited to, a video decoder 602, an indication data estimating unit 604, a controller 606, and a video frame buffer 608. The video decoder 602 selectively decodes a current video frame Fₙ under the control of the controller 606. The indication data estimating unit 604 is implemented for deriving an indication data S2 from a bitstream of the current video frame Fₙ before the current video frame Fₙ is decoded or skipped. In this exemplary embodiment, the indication data S2 includes information indicative of complexity of the current video frame Fₙ relative to previous video frame(s) such as F₀-Fₙ₋₁. The controller 606 is coupled to the video decoder 602 and the indication data estimating unit 604, and implemented for controlling the video decoder 602 to decode or skip the current video frame Fₙ by referring to at least the indication data S2. The operations and functions of blocks included in the signal processing apparatus 600 are detailed as follows.

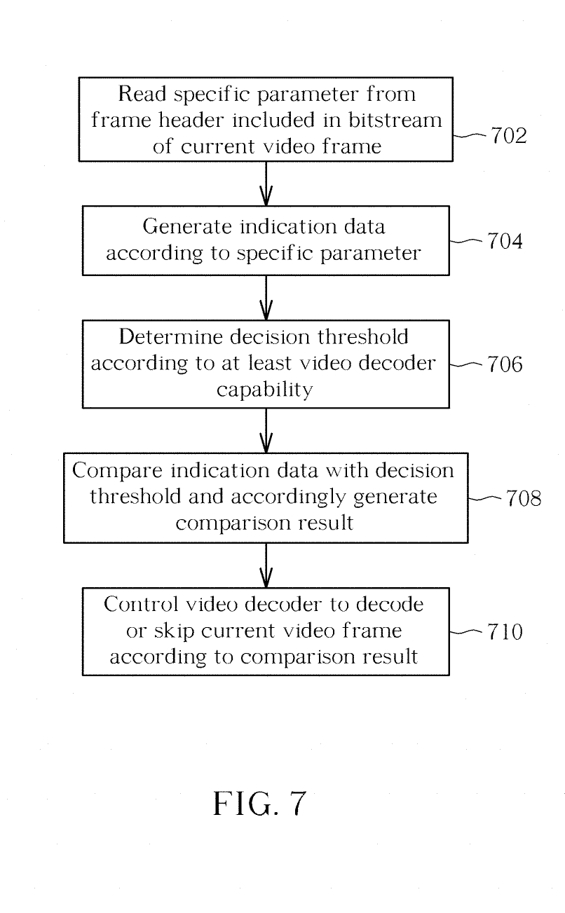

Please refer to FIG. 7, which is a flowchart illustrating a method employed by the signal processing apparatus shown in FIG. 6. Provided that the result is substantially the same, the steps are not required to be executed in the exact order shown in FIG. 7. The exemplary method for determining whether the current video frame should be skipped or decoded can be briefly summarized as follows.

Step 702: Read a specific parameter from a frame header included in a bitstream of a current video frame.

Step 704: Generate indication data according to the specific parameter.

Step 706: Determine a decision threshold according to at least the video decoder capability of a video decoder.

Step 708: Compare the indication data with the decision threshold and accordingly generate a comparison result.

Step 710: Control the video decoder to decode or skip the current video frame according to the comparison result.

In this exemplary embodiment, the indication data estimating unit 604 obtains the indication data S2 by performing steps 702 and 704. More specifically, the indication data estimating unit 604 generates the indication data S2 by calculating a weighted average value of the specific parameter and a historical average value derived from previous video frame(s), and determines the indication data S2 according to the specific parameter and the weighted average value. In one exemplary implementation, the indication data S2 transmitted to the controller 606 may be a value indicative of a ratio between the specific parameter and the weighted average value. In another exemplary implementation, the indication data S2 transmitted to the controller 606 may include the specific parameter and the weighted average value.

By way of example, but not limitation, the specific parameter used for determining the indication data may be a bitstream length/frame length of the current video frame Fₙ. Therefore, after the bitstream length L_{F}_{ₙ} of the current video frame Fₙ is read from the frame header of the current video frame Fₙ, the indication data estimating unit 604 calculates a weighted average value L_{T}_{ₙ} of the bitstream length L_{F}_{ₙ} and a historical average value L_{T}_{_{n−1}} derived from the previous video frames such as F₀-Fₙ₋₁. The weighted average value L_{T}_{ₙ} can be expressed as follows:

L_{T}_{ₙ}=α′×l_{T}_{_{n−1}}+(1−α′)×l_{F}_{ₙ} (14)

In above formula (14), α′ represents a weighting vector. The historical average value L_{T}_{_{n−1}} represents the historical statistics of bitstream lengths of the previous video frames. Therefore, the weighted average value L_{T}_{ₙ} will become the historical average value, representative of the historical statistics of bitstream lengths, for calculating a next weighted average value.

Next, the indication data estimating unit 604 determines the indication data S2 according to the weighted average value L_{T}_{ₙ} and the bitstream length L_{F}_{ₙ}. For example, the indication data estimating unit 604 determines the indication data S2 by a ratio between the bitstream length L_{F}_{ₙ} and the weighted average value L_{T}_{ₙ}. The indication data S2 therefore can be expressly as follows:

$$S 2 = \frac{{L}_{{F}_{n}}}{{L}_{{T}_{n}}} \qquad ( 15 )$$

As can be seen from formula (15), the indication data S2 may be regarded as a result of comparing the bitstream length of the current video frame with the historical statistics of bitstream lengths of previous video frames. The controller 606 controls the video decoder 602 to decode or skip the current video frame Fₙ by performing steps 706-710. Thus, the controller 606 decides whether the current video frame Fₙ will be skipped or decoded by referring to the result of comparing the bitstream length of the current video frame with the historical statistics of bitstream lengths of previous video frames. In this exemplary embodiment, the controller 606 determines a decision threshold R′ according to at least the video decoder capability of the video decoder 602, and controls the video decoder 602 to decode or skip the current video frame Fₙ according to a comparison result derived from the indication data S2 and the decision threshold R′. For example, the controller 606 compares the indication data S2 with the decision threshold R′ and accordingly generates a comparison result, and controls the video decoder 602 to decode or skip the current video frame Fₙ according to the comparison result.

As mentioned above, certain factors/parameters may reflect the video decoder capability of the video decoder 602. For example, the controller 606 may set the decision threshold R′ according to a ratio between a video decoder frame rate R1 and an input video frame rate R2 (e.g.,

$$\frac{R 1}{R 2} \text{)} ,$$

or set the decision threshold R′ according to a status of a video frame buffer 608 utilized for buffering decoded video frames generated from decoding video frames.

In an alternative design, the decision thresholds may be set or adaptively updated for different frame types, respectively. Therefore, the controller 606 sets the decision threshold R′ according to the ratio between the video decoder frame rate and the input video frame rate and a frame type of the current video frame Fₙ, or sets the decision threshold R′ according to the status of the video frame buffer 608 and the frame type of the current video frame Fₙ.

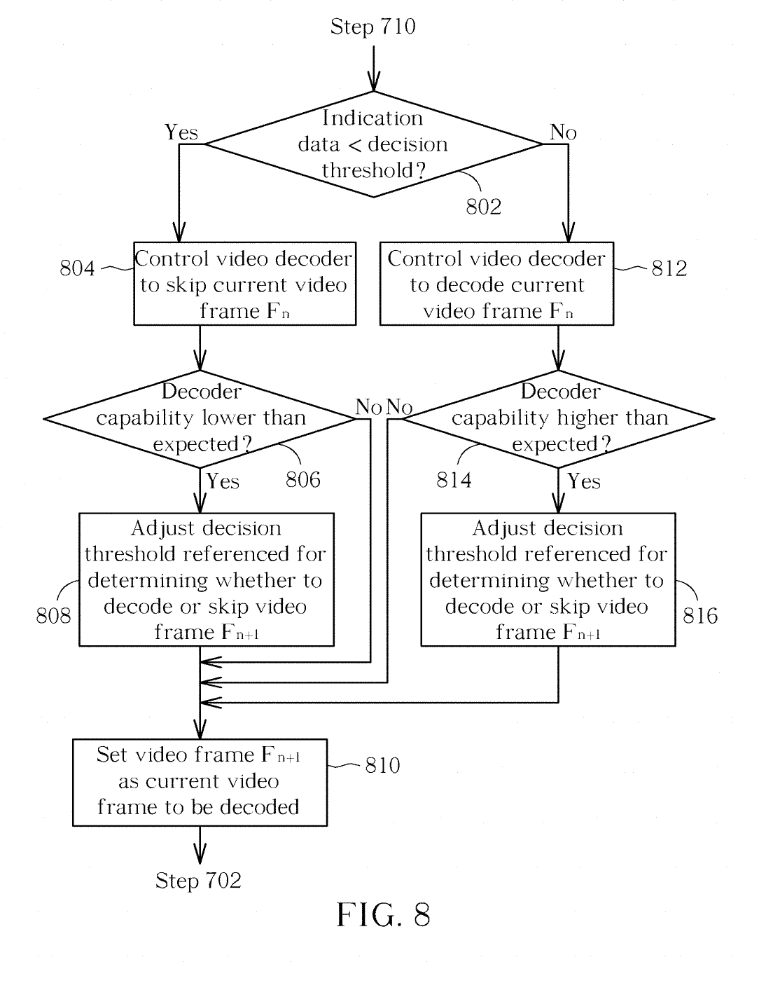

Please refer to FIG. 8, which is a flowchart illustrating a first exemplary design of step 710 shown in FIG. 7. The operation of controlling the video decoder 602 to decode or skip the current video frame Fₙ may include following steps.

Step 802: Check if the indication data S2 is smaller than the decision threshold R′. If yes, go to step 804; otherwise, go to step 812.

Step 804: Control the video decoder 602 to skip the current video frame Fₙ.

Step 806: Check if the video decoder capability of a video decoder 602 does not match (e.g., lower than) an expected video decoder capability. If yes, go to step 808; otherwise, go to step 810.

Step 808: Adjust the decision threshold R′ referenced for determining whether to decode or skip the next video frame Fₙ₊₁.

Step 810: Set the next video frame Fₙ₊₁ as a current video frame to be decoded. Go to step 702.

Step 812: Control the video decoder 602 to decode the current video frame Fₙ.

Step 814: Check if the video decoder capability of the video decoder 602 does not match (e.g., higher than) the expected video decoder capability. If yes, go to step 816; otherwise, go to step 810.

Step 816: Adjust the decision threshold R′ referenced for determining whether to decode or skip the next video frame Fₙ₊₁. Go to step 810.

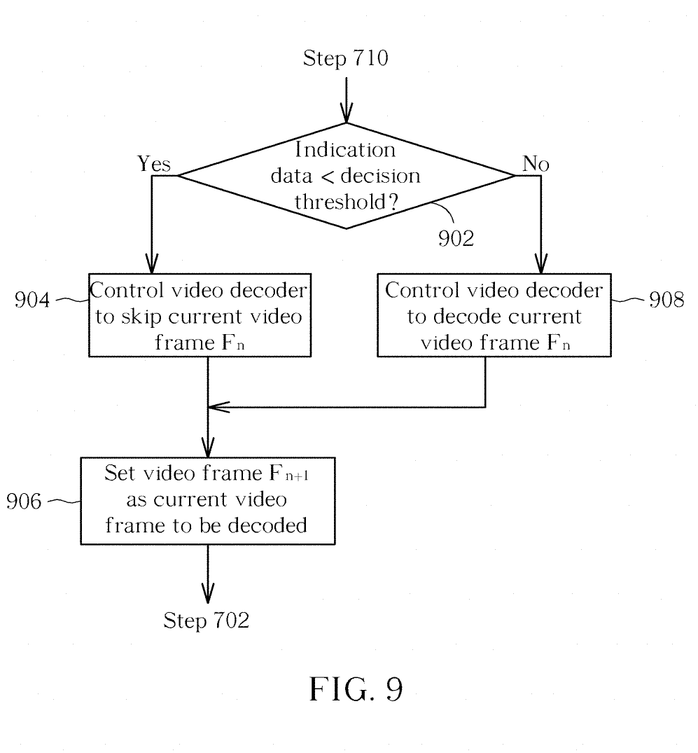

Please refer to FIG. 9, which is a flowchart illustrating a second exemplary design of step 710 shown in FIG. 7. The operation of controlling the video decoder 602 to decode or skip the current video frame Fₙ may include following steps.

Step 902: Check if the indication data S2 is smaller than the decision threshold R′(i). If yes, go to step 904; otherwise, go to step 908.

Step 904: Control the video decoder 602 to skip the current video frame Fₙ.

Step 906: Set the next video frame Fₙ₊₁ as a current video frame to be decoded. Go to step 702.

Step 908: Control the video decoder 102 to decode the current video frame Fₙ. Go to step 906.

It should be noted that the aforementioned rules of determining the decision threshold R/R(k) may be employed for determining the decision threshold R′/R′(i). As a person skilled in the art can readily understand details of the steps in FIG. 8 and FIG. 9 after reading above paragraphs directed to the flowcharts shown in FIG. 3 and FIG. 4, further description is omitted here for brevity.

In above exemplary embodiments, the indication data estimating unit 104/604 determines the indication data S1/S2 by the ratio between the accumulation value and the weighted average accumulation value/the ratio between the weighted average value and the bitstream length. However, in an alternative design, the indication data estimating unit 104/604 may output the indication data S1/S2, including the accumulation value and the weighted average accumulation value/the weighted average value and the bitstream length, to the following controller 106/606. Next, the controller 106/606 checks a comparison result derived from the indication data S1/S2 (which includes the accumulation value and the weighted average accumulation value/the weighted average value and the bitstream length) and the decision threshold R/R′ to thereby determine if the next video frame/the current video frame should be skipped or decoded. This also obeys the spirit of the present invention and falls within the scope of the present invention.

Consider a case where the controller 106/606 decides that a specific video frame (e.g., the next video frame in the aforementioned signal processing apparatus 100 or the current video frame in the aforementioned signal processing apparatus 600) should be skipped. In one exemplary design, if the skipped specific video frame is a P-frame or B-frame, the display apparatus may display a decoded video frame generated from decoding a video frame preceding the specific video frame again during a period in which a decoded video frame generated from decoding the specific video frame is originally displayed. In another exemplary design, if the skipped specific video frame is a B-frame, the display apparatus may display a decoded video frame generated from decoding a video frame following the specific video frame during a period in which a decoded video frame generated from decoding the specific video frame is originally displayed. In yet another exemplary design, the display apparatus may directly skip the video playback associated with the specific current video frame, thereby increasing the playback speed. This may be employed when the video playback delay occurs or the fast-forward operation is activated.

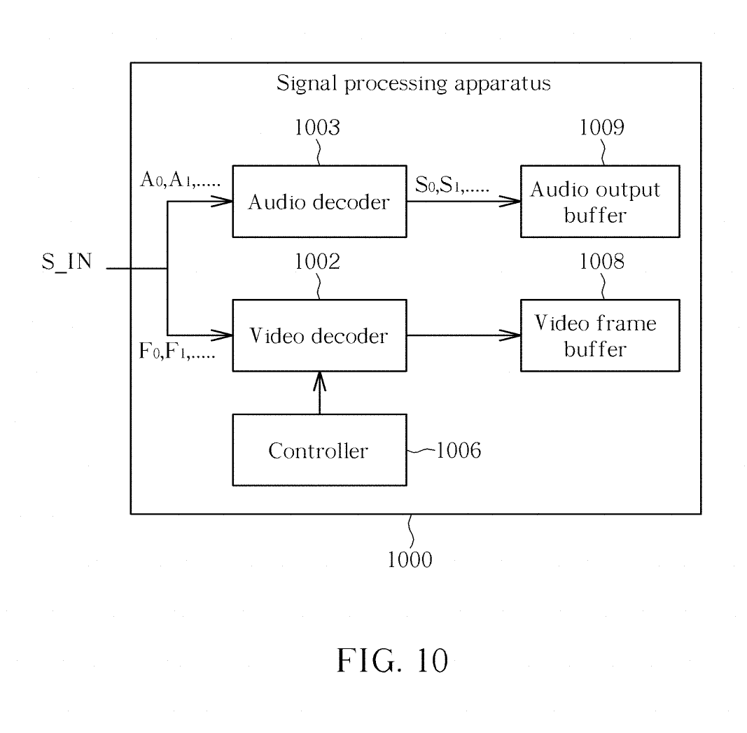

FIG. 10 is a diagram illustrating a signal processing apparatus according to a third exemplary embodiment of the present invention. The exemplary signal processing apparatus 1000 is for processing an input bitstream S_IN including a plurality of encoded/compressed video frames (e.g., F₀, F₁, etc.) and a plurality of encoded/compressed audio frames (e.g., A₀, A₁, etc.). The exemplary signal processing apparatus 1000 includes, but is not limited to, a video decoder 1002, an audio decoder 1003, a controller 1006, a video frame buffer 1008, and an audio output buffer 1009. The audio decoder 1003 is arranged to decode the encoded/compressed audio frames and accordingly generate decoded audio samples (e.g., S₀, S₁, etc.) to the audio output buffer 1009. The video decoder 1002 selectively decodes the encoded/compressed video frames under the control of the controller 1006. Any decoded video frame generated from the video decoder 1002 will be buffered in the video frame buffer 1008. In this exemplary embodiment, the controller 1006 is coupled to the video decoder 1002, and implemented for controlling the video decoder 1002 to skip part of the video frames transmitted by the input bitstream S_IN while the decoded audio samples stored in the audio output buffer 1009 are being continuously outputted for audio playback.

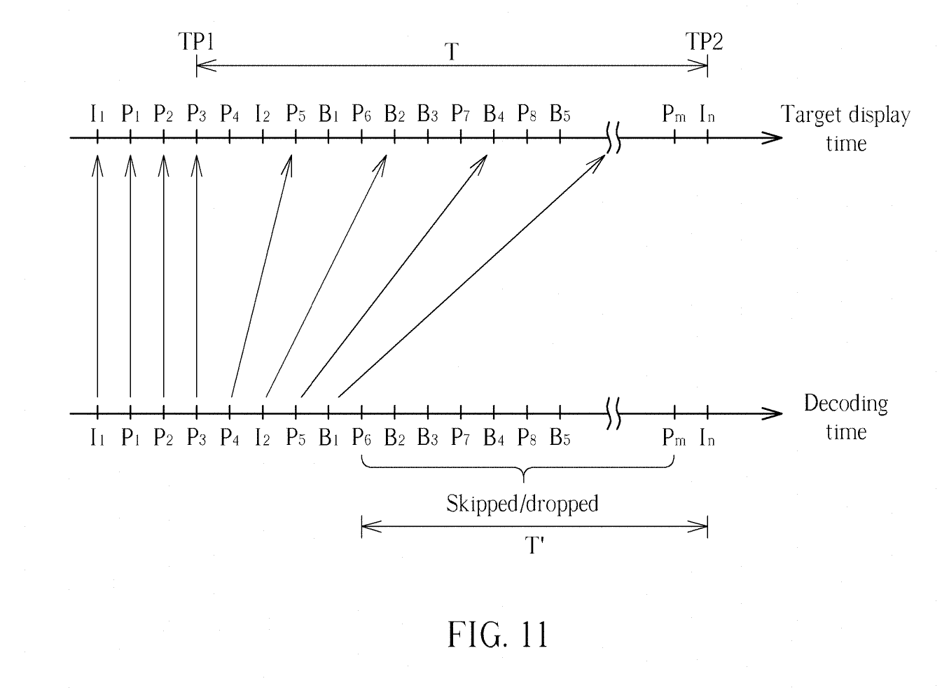

Please refer to FIG. 11, which is a diagram illustrating an operational scenario of the signal processing apparatus 1000 shown in FIG. 10 according to an embodiment of the present invention. As shown in FIG. 11, the decoded video frames of the input video frames, including I-frame I₁ and P-frames P₁-P₃, are buffered in the video frame buffer 1008 and will be correctly displayed at the target display time. That is, the video playback and the audio playback are synchronized with each other. After the video decoder 1002 generates a decoded video frame of the input video frame B₁, the controller 1006 detects that the total number of decoded video frames (e.g., decoded video frames of first frames including input video frames P₄, I₂, P₅, and B₁) available in the video frame buffer 1008 is smaller than a threshold value (e.g., 5), implying that the current decoder capability of the video decoder 1002 may be insufficient to generate decoded video frames in time for fluent video playback. The controller 1006 therefore adjusts an original video display timestamp of each of the decoded video frames currently available in the video frame buffer 1008, and controls the video decoder 1002 to skip the video frames P₆-Pₘ following the latest video frame B₁ decoded by the video decoder 1002. As shown in FIG. 11, the skipped part of the video frames transmitted by the input bitstream S_IN has an ending frame Pₘ preceding a second frame (i.e., a particular video frame Iₙ). The particular video frame Iₙ may be an I-frame closest to the latest video frame B₁ decoded by the video decoder 1002 (i.e., Iₙ=I₃). Thus, the skipped part of the video frames transmitted by the input bitstream S_IN has no I-frame included therein. However, this is for illustrative purposes only, and is not meant to be a limitation of the present invention. That is, in an alternative design, the skipped part of the video frames transmitted by the input bitstream S_IN may have one or more I-frames (e.g., I₃ and/or I₄) included therein.

In this exemplary embodiment, the controller 1006 may estimate a time period T between a video display time point TP1 of a decoded video frame of the video frame P₃ preceding the video frame P₄ and a video display time point TP2 of a decoded video frame corresponding to the particular video frame Iₙ, and then adjust the original video display timestamp of each of the decoded video frames available in the video frame buffer 1008 according to the time period T. For example, the adjusted display time points of these decoded video frames in the video frame buffer 1008 may be evenly distributed within the time period T.

Consider another case where the decoded video frame of the input video frame P₃ has been outputted from the video frame buffer 1008 for video playback and the next input video frame P₄ is not decoded yet. Therefore, the video frame buffer 1008 becomes empty, and the video playback and the audio playback would be out of synchronization. After the video frame buffer 1008 becomes empty (i.e., after the video playback and the audio playback are out of synchronization), the controller 1006 allows the video decoder 1002 to decode some input video frames (e.g., P₄, I₂, P₅, and B₁), and then controls the video decoder 1002 to skip the following video frames P₆-Pₘ for re-synchronizing the video playback and the audio playback. In other words, due to the frame skipping action, the video decoder 1002 will start to decode the particular video frame Iₙ immediately after the decoding of the input video frame B₁ is accomplished. The particular video frame Iₙ may be an I-frame closest to the latest video frame B₁ decoded by the video decoder 1002. However, in an alternative design, the skipped part of the video frames may have one or more I-frames included therein. Similarly, the controller 1006 may estimate a time period T between a video display time point TP1 of a decoded video frame of the video frame P₃ preceding the video frame P₄ and a video display time point TP2 of a decoded video frame corresponding to the particular video frame Iₙ, and adjust the original video display timestamp of each of the decoded video frames (e.g., decoded video frames of input video frames P₄, I₂, P₅, and B₁) according to the time period T. For example, the adjusted display time points of these decoded video frames generated under a condition where the audio playback and video playback are out of synchronization may be evenly distributed within the time period T.

To put it simply, with the help of the adjustment made to the original video display timestamps of some decoded video frames, the video decoder 1002 can gain the decoding time period T′ available for generating decoded video frames to the video frame buffer 1008. In this way, at the end of the time period T, the audio playback and video playback may be synchronized again.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for processing an input bitstream including a plurality of video frames, the method comprising:
deriving an indication data from a bitstream of a current video frame before the current video frame is decoded or skipped; and
controlling a video decoder to decode or skip the current video frame by referring to at least the indication data,
wherein the indication data is generated based on a value of a bitstream length of the current video frame.

2. The method of claim 1, wherein the indication data include information indicative of complexity of the current video frame relative to previous video frame(s).

3. The method of claim 1, wherein the step of deriving the indication data comprises:
reading the bitstream length of the current video frame from a frame header included in the bitstream of the current video frame; and
generating the indication data based on the value of the bitstream length of the current video frame.

4. The method of claim 3, wherein the step of generating the indication data comprises:
calculating a weighted average value of the bitstream length of the current video frame and a historical average value derived from the previous video frames; and
determining the indication data based on the value of the bitstream length of the current video frame and the weighted average value.

5. The method of claim 4, wherein the weighted average value is calculated based on:
L_{Tn}=α′×L_{Tn-1}+(1−α′)×L_{Fn},
wherein L_{Tn} is the weighted average value, α is a weighting factor, L_{Tn-1} is the historical average value of bitstream lengths of previous video frames, and L_{Fn} is the bitstream length of the current video frame.

6. The method of claim 5, wherein the indication data is generated based on:
S2=L_{Fn}/L_{Tn},
wherein S2 is the indication data, L_{Fn} is the bitstream length of the current video frame, and L_{Tn} is the weighted average value.

7. The method of claim 1, wherein the step of controlling the video decoder to decode or skip the current video frame comprises:
controlling the video decoder to decode or skip the current video frame based on the indication data and a video decoder capability of the video decoder.

8. The method of claim 7, wherein the step of controlling the video decoder to decode or skip the current video frame comprises:
determining a decision threshold based on at least the video decoder capability of the video decoder; and
controlling the video decoder to decode or skip the current video frame based on a comparison result derived from the indication data and the decision threshold.

9. The method of claim 8, wherein the step of determining the decision threshold comprises:
setting the decision threshold based on at least a status of a video frame buffer utilized for buffering decoded video frames generated from decoding video frames.

10. The method of claim 9, wherein the step of setting the decision threshold comprises:
setting the decision threshold based on the status of the video frame buffer and a frame type of the current video frame.

11. The method of claim 8, wherein the step of determining the decision threshold comprises:
setting the decision threshold based on at least a ratio between a video decoder frame rate and an input video frame rate.

12. The method of claim 11, wherein the step of setting the decision threshold comprises:
setting the decision threshold based on the ratio and a frame type of the current video frame.

13. The method of claim 8, further comprising:
when the video decoder capability of the video decoder is different from an expected video decoder capability, adjusting the decision threshold.

14. The method of claim 1, wherein when the current video frame is skipped by the video decoder:
if the current video frame is a predictive frame (P-frame), a decoded video frame generated from decoding a video frame preceding the current video frame is displayed again during a period in which a decoded video frame generated from decoding the current video frame is originally displayed;
if the current video frame is a B-frame, a decoded video frame generated from decoding a video frame following the current video frame or a decoded video frame generated from decoding the current video frame is displayed during a period in which the decoded video frame generated from decoding the current video frame is originally displayed; or
a video playback associated with the current video frame is skipped.

15. The method of claim 1, wherein the value of the bitstream length of the current video frame is a numerical value.

16. A signal processing apparatus comprising:
processing circuitry including:
a video decoder;
an indication data estimator that derives an indication data from a bitstream of a current video frame before the current video frame is decoded or skipped; and
a controller that controls the video decoder to decode or skip the current video frame by referring to at least the indication data,
wherein the indication data is generated based on a value of a bitstream length of the current video frame.
